(19) United States
(12) Patent Application Publication
(10) Pub. No.: US 2001/0043683 A1
(43) Pub. Date: Nov. 22, 2001

(54) Communications system and apparatus

(76) Inventors: Amold Albert Wilson, London (GB); Azhar Mahmood Chaudhary, Leicester (GB)

Correspondence Address: ST. ONGE STEWARD JOHNSTON & REENS, LLC, 986 BEDFORD STREET, STAMFORD, CT, 06905-5619, US

(21) Appl. No.: 09/887,615

(22) Filed: Jun. 22, 2001

Related U.S. Application Data
(63) Continuation of application No. PCT/GB99/04372, filed on Dec. 22, 1999.

(30) Foreign Application Priority Data
Dec. 23, 1998 (GB) 9828600.8

(51) Int. Cl. H04M 11/00

(52) U.S. Cl. 379/88.16

(57) ABSTRACT

A communications system generally comprises communications apparatus 1 which is connected via a communications link 2 to a user's computer system 3 and via a telephone system 4 to a plurality of telephones 5 each belonging to a call recipient. The basic functioning of the communications system is as follows. The user whose computer system 3 is connected to the communications apparatus 1 has information stored in the computer system 3 which either he wishes to deliver to the call recipients or which the call recipients wish to obtain. This information is received by the communications apparatus 1 and at an appropriate time the communications apparatus 1 automatically calls the telephone 5 of the correct call recipient and delivers an audible voice message via the telephone system 4 to the telephone 5 of the call recipient.

This invention relates to communications systems, communications apparatus for use with communications systems and methods of operating computers to generate files for use with communications apparatus.

In many situations it is desirable for one party, for example a supplier to be able to deliver information to another party, for example a client or customer. It is also desirable to allow clients or customers to obtain information on their own initiative.

There are existing systems for making information available but these have limitations. The applicants have appreciated that it is desirable to deliver particular messages to selected individuals and that delivering information in written form has disadvantages. Expensive and specialised equipment is needed to receive the information and written incoming messages can easily be put to one side for later consideration without the delivered message having been read and understood.

It is an object of at least some aspects of the present invention to provide an improved communications system or a communications apparatus for use in a communications system.

According to a first aspect of the present invention there is provided a communications apparatus for use with a communications system comprising,

storage means for storing information, controllable message generating means for generating messages based on information stored in the storage means,

controllable connecting and transmission means for connecting to terminals via a communications system and transmitting generated messages to said terminals, and

control means for controlling the message generating means and the connecting and transmission means in such a way that, in use, generated messages are delivered to selected recipients via selected terminals when predetermined conditions are satisfied.

It is advantageous if messages can be delivered as voice messages via the telephone of the recipient. The communications apparatus can be arranged for connection to a telephone system. The connecting and transmission means can be a dialling and transmission means.

According to a second aspect of the present invention there is provided a communications apparatus connectable to a telephone system comprising,

storage means for storing information, controllable message generating means for generating messages based on information stored in the storage means,

controllable dialling and transmission means for dialling numbers of telephones in a telephone system to which the apparatus is connected and transmitting generated messages to said telephones, and

control means for controlling the message generating means and the dialling and transmission means in such a way that, in use, generated voice messages are delivered to selected recipients via selected telephones when predetermined conditions are satisfied.

Using such a communications apparatus it is possible to deliver a large number of telephone calls to selected recipients without human intervention. In many cases the users of the system, as distinct from the recipients, will be suppliers who wish to transmit information to their customers, the recipients. The fact that the apparatus may be arranged so that data stored in the storage means can be used directly to generate messages, can increase flexibility and/or ease of implementation compared to a system in which pre-recorded messages are delivered.

The information stored can comprise details of recipients who are to be called. Information stored in the storage means may be arranged in message files each of which is associated with a particular recipient or group of recipients. The contents of the message file can be used by the communications apparatus to generate and deliver appropriate messages at the correct times. Generated messages can be specific to each recipient or a group of recipients. Typically files will contain any one of or any combination of the following: recipients' names and numbers, information from which messages can be generated, dates and times at which messages will be delivered and details of trigger events which will trigger the delivery of a message.

A trigger event is a future event the timing of which may be unknown. The control means can be arranged so that a particular recipient or group of recipients are delivered messages when a specified trigger event occurs. An example might be the price of a particular commodity falling below a selected threshold. Once that threshold is reached appropriate calls are triggered.

A template can be associated with each recipient and/or each message file. The template can have fixed elements and variable elements. When processed, fixed elements may generate a text string which is common to all message associated with that template. Variable elements may be determined by a user and can allow recipient specific information to be introduced into a message.

Said predetermined conditions can, for example, comprise any one of or any combination of: dates, times and the occurrence of trigger events. The predetermined conditions can be different for each recipient. The same predetermined conditions can be associated with a group of recipients.

A recipient may have a plurality of associated telephone numbers. The numbers may have a ranking and the control means can be arranged so that one number is tried first and the subsequent number or numbers are only tried if using the previous number(s) is unsuccessful, for example if there is no answer or the line is engaged. The plurality of associated numbers may comprise numbers which are to be used at different times, for example there may be a daytime number and an evening number.

The communication apparatus can comprise receiving means for receiving information to be stored in the storage means and/or passed onwards. The receiving means can comprise a keyboard and/or a data reader so that information can be input manually and/or using a data carrier. The receiving means can be arranged so that users and/or recipients can input information from a remote location via a communication link. The communications link may, for example, be direct or make use of the internet.

Any or all of these means may be used to input information into the storage means which can then be used to generate and control the generation of appropriate messages for transmission. In many cases a user of the system will supply information in one of these ways so that appropriate messages can be sent to their customers. The ability of the apparatus to receive data from a user which can be used as the basis of a message is an important feature. The transmission of this data via a communications link is particularly advantageous as it can further reduce the amount of human involvement needed.

A database may be provided at a remote location. The remote database may be located at a user's computer system. The receiving means can be arranged so that information from the remote database can be sent to and/or called for by the communications apparatus. This can increase the level of automation in the message generation and delivery process and can help to facilitate the inclusion of up to date information in messages. In such cases information may only be transiently stored in the storage means before being forwarded to a recipient.

The operation of the user's computer can be controlled by software to generate message files suitable for transfer to the communications apparatus.

Typically where a recipient inputs information it will be in response to requests for information contained in the message transmitted to him. The receiving means can be arranged so that information from a recipient can be received via the telephone system which has been used to make the call to the recipient. In such a case, the information can be input by a recipient using his telephone keypad and/or simply giving a verbal response. The receiving means can be arranged so that when verbal responses are given these are recorded as voice mail messages and/or voice recognition software is used to analyse the input. Where a generated message requests feedback an appropriate pause can be included to allow the information to be input. The communications apparatus can be arranged so that subsequent parts of a message will depend on the response received.

Typically the information input by recipients will be of interest to the user whose message has been transmitted. The system can be arranged so that information can be output for delivery to a user or another party.

Output means for outputting the responses given by recipients can be provided. The output means may include a printer so that a hard copy of the responses can be produced. The output means may be arranged so that the responses can be received at a remote location via a communication link. This link may be direct or make use of the internet. The output can comprise data in an electronic form for transfer onto a computer system and/or a voice message transmitted to a user via a telephone. Where the message is transmitted via a telephone the apparatus can operate in the same way as when a call is transmitted to a recipient. The dialling and transmission means can comprise the output means.

The communications apparatus can be arranged for administering requests for future information. In such a case an appropriate message will be sent to the requesting recipient when the information requested becomes available. The person desiring the information requests it as a user and receives it via telephone as a recipient as described above. The availability of the information is a trigger event.

The communications apparatus can be arranged for administering a virtual bidding system. In particular bids for future information can be administered. When requesting the future information a bid can be made to receive the information on a preferential basis for example, first or exclusively. The apparatus can be arranged to deliver the information to the highest bidder or bidders. The apparatus can be arranged to inform existing bidders if higher bids are made.

It will be appreciated that, in general, users can also be recipients and vice versa.

The communications apparatus can comprise any one of or any combination of a data management subsystem, a call delivery and feedback subsystem, a voice communications subsystem, a data communications subsystem and a future information subsystem.

The communications apparatus typically comprises hardware and controlling software elements which combine to provide the functions of the storage means, the controllable message generating means, the controllable dialling and transmission means/controllable connecting and transmission means and the control means.

In one group of embodiments the communications apparatus comprises a network server and at least one telephony board with voice synthesis capabilities. Under the control of software the network server may be arranged for acting as the data management subsystem and/or the call delivery and feedback subsystem. Under the control of software the telephone board may be arranged for acting as the voice communications subsystem.

The storage means may comprise the data management subsystem. The message generating means may comprise the voice communications subsystem. The dialling and transmission means may comprise the voice communications subsystem. The control means may comprise the data management subsystem, the call delivery and feedback subsystem and the voice communications subsystem.

In developments the communications apparatus can comprise at least one high capacity data board. Under the control of software the data board can be arranged for acting as the data communications subsystem.

The receiving means can comprise the data communications subsystem and/or the voice communications subsystem. The output means can comprise the data communications subsystem and/or the voice communications subsystem.

In developments the communications apparatus can comprise at least one additional server which may be connected to the network server by LAN or WAN. Under the control of software the network server and/or the additional server can be arranged for acting as the future information subsystem. The data management subsystem can act as a future information subsystem. The future information subsystem can be arranged to administer future information requests and bids for future information.

According to a third aspect of the invention there is provided a communications system comprising a telephone system and a communication apparatus according to the first or second aspect of the invention. In addition to the telephone system, the communications system may also comprise at least one communications link. The communication system may further comprise one or more computers systems at remote locations connectable to the communications apparatus via the communication link.

According to a fourth aspect of the present invention there is provided a method of operating a computer system to generate message files for use in the generation of messages in a communications apparatus comprising the steps of:

allowing a user to identify details of recipients who are to be called by the communications apparatus;

allowing a user to identify other information from which messages to be transmitted by the communications apparatus can be generated; and

associating a template which is recognised by the communications apparatus with the identified details and other information to generate message files.

It will be appreciated that the computer system mentioned in the fourth aspect of the invention may be used with or form part of the communications apparatus of the first or second aspect and may form part of the communications system of the third aspect. Preferably where the computer system is distinct from the communications apparatus, the generated message files are transferred to the communications apparatus via a communication link.

The identified details and/or other information may be located in a user's database. The method can comprise the step of extracting identified details and/or other information from a database. Typically the message content will be input by a user, for example using a keyboard.

A plurality of different templates can be provided. Each can be suitable for different circumstances. A template may be structured so that the resulting message generated by the communications apparatus has no feedback requirement. A template may be structured so that the generated message requests feedback. A template can have a conditional structure so that a subsequent part of a message and/or subsequent action is dependent on the feedback given.

The use of templates allows the user to have great flexibility when specifying the message structure and content, whilst allowing the resulting message files to be processed by the communications apparatus.

Embodiments of the present invention will now be described, by way of example only, with reference to the accompanying drawings in which:

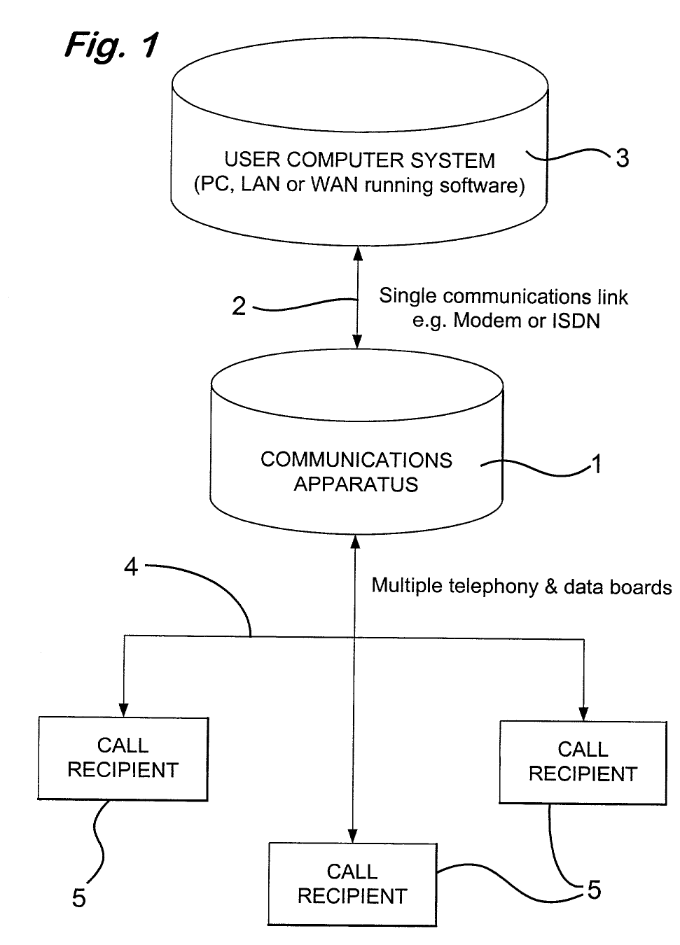

FIG. 1 is a simple schematic view of a communications system;

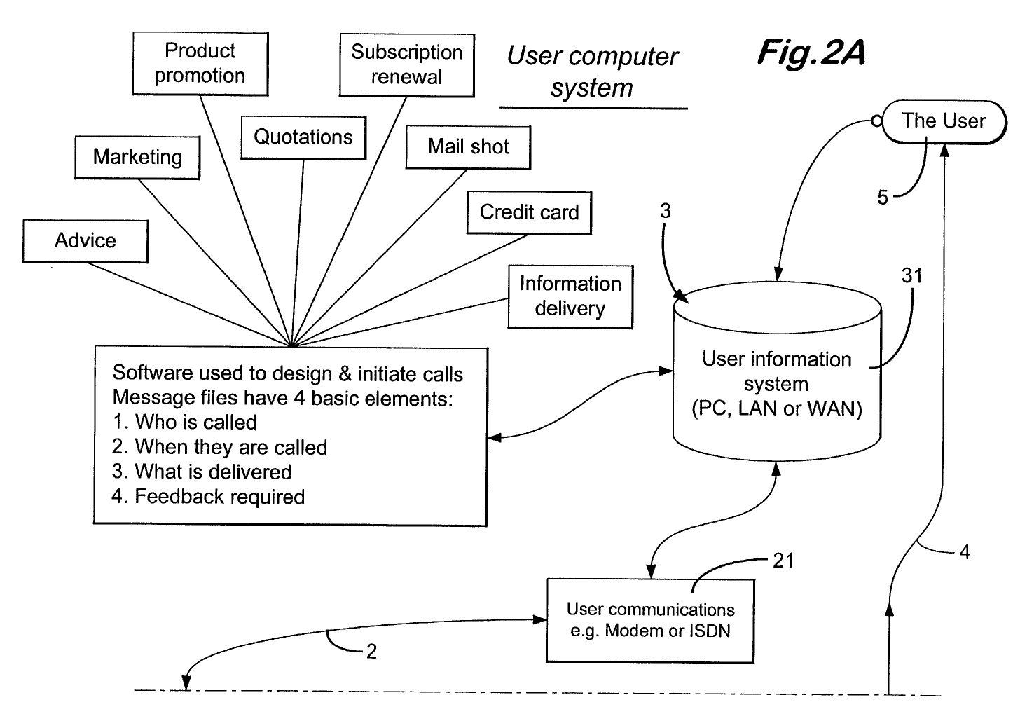

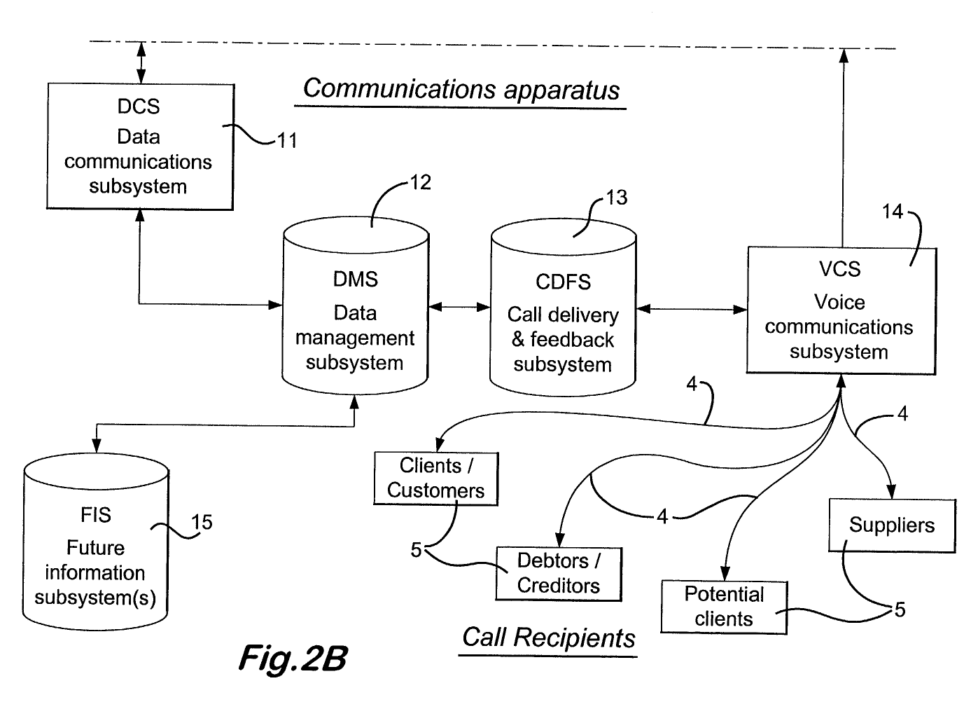

FIGS. 2A and 2B are a more detailed systematic view of the communications system shown in FIG. 1; and

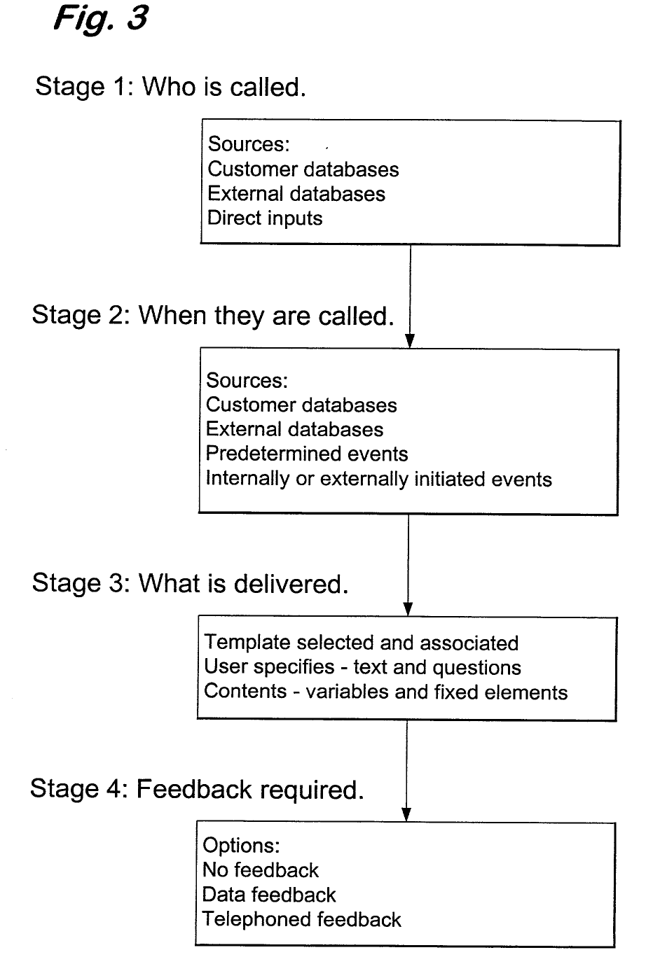

FIG. 3 is a flow chart schematically showing the process used to generate message files for transfer to the communications apparatus.

A communications system generally comprises communications apparatus 1 which is connected via a communications link 2 to a user's computer system 3 and via a telephone system 4 to a plurality of telephones 5 each belonging to a call recipient.

The basic functioning of the communications system is as follows. The user whose computer system 3 is connected to the communications apparatus 1 has information stored in the computer system 3 which either he wishes to deliver to the call recipients or which the call recipients wish to obtain. This information is received by the communications apparatus 1 and at an appropriate time the communications apparatus 1 automatically calls the telephone 5 of the correct call recipient and delivers an audible voice message via the telephone system 4 to the telephone 5 of the call recipient. This procedure can be carried out without any human intervention by the user or the operator of the communications apparatus 1. Therefore a large number of telephone calls can be delivered to recipients via their telephones 5 at times determined by the communications apparatus 1 on the basis of instructions from a user. It should be appreciated that the information is stored at the communications apparatus 1 as normal data and not as a recorded speech file. The communications apparatus 1 processes the data to generate the message as synthesised speech.

Although a single user's computer system 3 is shown in FIG. 1 it will be appreciated that a large number of users can have computer systems connected via suitable communications links to the communications apparatus 1. Each user can then use the system in the way described above.

FIGS. 2A and 2B show the communications system in more detail. The communications apparatus 1 comprises a data communications subsystem 11 which allows the communications apparatus 1 to be connected via the communications link 2 to the user's computer 3. The data communications subsystem 11 interacts with a data management subsystem 12 which in turn interacts with a call delivery and feedback subsystem 13. The call delivery and feedback subsystem 13 interacts with a voice communications subsystem 14 which enables audible voice messages to be sent to call recipients via the telephone system 4 and their telephones 5. The voice communications subsystem 14 is also arranged so that it can receive information or feedback input by a call recipient using his telephone 5. The communications apparatus 1 also comprises a future information subsystem 15 which interacts with the data management system 12.

The communications link 2 which connects the communication apparatus 1 to the user's computer system 3 comprises the user's communications device 21 for example an modem or ISDN connection.

The main hardware components of the communications apparatus 1 comprise an industry standard network server which under the control of appropriate software functions as the data management subsystem 12 and the call delivery and feedback subsystem 13. The network server is connected to one or more other servers which under the control of appropriate software, function as future information subsystems 15 (only one of which is shown). The network server is also connected to a plurality of high capacity data boards including for example high speed modems and ISDN connections which under the control of appropriate software act as the data communications subsystem 11. These high capacity data boards allow data to be transmitted between the communications apparatus 1 and users' computer systems 3. The network server is also connected to a plurality of industry standard telephony boards which have voice synthesis capabilities. These boards under the control of appropriate software form the voice communications subsystem 14. The telephony boards allow messages from the communications apparatus 1 to be delivered to recipients via the telephone system 4 and the recipients' telephones 5.

The user's computer system 3 is operated under the control of software to generate message files which are suitable for transmission to the communications apparatus 1. FIG. 3 schematically shows the process used to generate such files. Each message file has 4 basic elements:

1 Who is to be called

2 When they are to be called.

3 What is to be delivered.

4 Details of feedback required.

Each message file may be associated with a single recipient or a group of recipients. The details of who is to be called can be extracted under the control of the software from customer databases held in a user's information system 31 located at their computer system 3 or from external databases at other locations. Alternatively the user can directly input details of who is to be called. This occurs in stage 1, as shown in FIG. 3. The details specified at this stage will include the recipient's name and telephone number and optionally alternative telephone numbers.

In stage 2, as shown in FIG. 3, details of when the call or calls should be made are specified. The timings can be left at a default value or specified by a user. The system is arranged so that when several different numbers are associated with a single recipient, each number can be given a time range in which it will be called. For example a recipient may have a specified day time number and a specified evening number.

The time at which a call is to be made can be entered as a specific time on a specific date or can be set to occur once a specified trigger event has taken place. A trigger event can be any future event the timing of which may be unknown. For example it may be specified that a call should be made once the price of a commodity falls below a certain threshold or that a call should be made when an existing insurance policy is about to expire.

For this purpose a message file can be dynamically linked to a user's database or an external database. The communications system can then be arranged so that when that database is updated to show that a trigger event has occurred this fact is automatically transferred to the communications apparatus 1 so triggering the appropriate call.

In stage 3, as shown in FIG. 3, the information which is to be given to the recipient as an audible voice message is specified. The message structure and content is prepared using templates which are recognised by the communications apparatus 1.

All message files must use a recognised template. This is because of the way outgoing messages are generated and to create a standard to facilitate international transmission. Templates can be automatically translated by the apparatus to produce a voice message in the desired language.

The user specifies the text for the message and, where appropriate, what questions should be asked. The content of the message can be dynamically linked to databases at the user's computer system 3 or elsewhere so that the up-to-date contents of the database can be included in the message when the message is generated and transmitted by the communications apparatus 1.

As an example, if the message to be delivered is an insurance quotation, the time at which the message is delivered to the recipient can be determined by the expiry date of the recipient's existing insurance policy. Moreover the message file can be dynamically linked to an appropriate database enabling a quotation to be inserted in the message which is correct when generation of the message is initiated. In other examples the message which is sent might be a reminder that payment is due or overdue or a warning that an account balance is low.

In general the message can be based on fixed elements determined by the template, pre-known variable elements such as recipients' names and future information elements the precise contents of which will not be known until the time at which the message is generated.

The same template can be used for the generation of similar messages to a very large number of recipients. For example the template may allow a common element of text to be specified into which the name of each recipient is introduced when the messages are generated by the communications apparatus 1.

A template may be arranged so that questions can be asked to which a recipient is expected to give a response or feedback. The templates can allow the message to have a conditional structure so that the contents of the feedback effects the later parts of the message or effects other action which is taken.

In one example a message may be sent to a group of customers advertising that a consignment of goods is available at a certain price per tonne. Each recipient can be asked whether they are interested in purchasing any of that consignment. If a recipient responds positively the communications apparatus 1 can be arranged so that an appropriate message is forwarded to the user. The user can then make further arrangements for the supply of goods required.

In stage 4, as shown in FIG. 3, the user specifies what, if any, feedback is required and the way in which that feedback should be provided to the user. There are two general kinds of feedback which the communications apparatus 1 can supply. The first is data feedback which is essentially a data file summarising the responses given by the recipients. This may be transmitted to the user in electronic form for example by using the communications link 2 or as faxed feedback or perhaps as hard copy. The other form of feedback is telephoned feedback in which the communications apparatus 1 delivers a message to the user via the telephone system 4 and the user's telephone 5 in the same way in which the message was initially sent to the recipient.

The different types of feedback will be appropriate in different circumstances. For example if the system is used to conduct market research then feedback in the form of a data file is probably appropriate. However, if the system is used by a supplier offering his customers an opportunity to buy goods, as mentioned above, then an immediate response by telephone may be more appropriate.

A more detailed description of the operation of the communications apparatus will now be given.

Message files indicating the calls to made on behalf of a user which have been generated using a user's computer system 3 under the control of software as described with reference to FIG. 3 are down loaded via the communications link 2 and the data communications subsystem 11 to the data management subsystem 12. The data management subsystem 12 is arranged to organise all the incoming files and schedule them for delivery.

At the time when a message is to be sent, either because a specified time has been reached or a trigger event has occurred, the data management subsystem 12 initiates the process. Once the process is initiated the call delivery and feedback subsystem 13 is arranged to control the allocation and routing of the message for delivery. Once this task has been performed the appropriate message file from the data management subsystem 12 is directed to the voice communications subsystem 14.

The voice communication subsystem 14 recognises the template associated with the message file which it has received. The voice communication subsystem 14 combines the variable elements of the message file with the fixed elements of the appropriate template. This process creates a complete message text dialogue stream. The voice communications subsystem 14 then extracts the telephone number to be dialled from the message file and dials it. Industry standard software tools then control the interaction between the communications apparatus 1 and the recipient.

The voice communication subsystem 14 converts the message from a text string into a voice message using industry standard text to speech software. If it is a multi-part message then only the first part of the message is at this stage converted to speech. This voice message is then transmitted to the recipient via his telephone 5. If the message requires a response, the recipient can give his desired response either by using the key pad of his telephone 5 or by simply making a spoken response.

Subsequent action will depend on the template being used and the response which is given. The response given may determine the next speech string element which is converted by the voice communication subsystem 14 and sent to the user via his telephone 5.

Where feedback is generated in a call, the voice communication subsystem 14 first directs this feedback to the call delivery and feedback subsystem 13 which then returns the results to the data management subsystem 12 for collation. The data management subsystem 12 then organises the delivery of the feedback in accordance with the user's instructions. The feedback can be delivered as a structured data file or as a telephone message.

If the feedback is to be delivered in the form of a data file, this file is passed to the data communication subsystem 11 and it is then uploaded to the user's computer system 3 via the communication link 2.

On the other hand, if the feedback is to be in the form of a telephone call, the data management subsystem 12 compiles the feedback into an appropriate message file (in a similar way to that shown in FIG. 3) which can be passed to the voice communication subsystem 14 and processed in the way described above to generate a audible voice message to be delivered via the telephone 5 of the user.

In this way the communications apparatus 1 can generate new calls based on the responses given in earlier calls. Through this mechanism the communications apparatus 1 can generate a succession of calls based on any conditional scenario. For example, as described in more detail below, the communications apparatus 1 can administer a bidding exchange.

Besides the above specific functions, the data management subsystem 12 also generally manages and administers the entire system. It runs the billing system and ensures that user accounts are in order.

In a particular application, the communications apparatus 1 can be used to create a market in future information. Requests for future information are stored as message files in the future information subsystem 15 or in one such subsystem if there are a number of them.

In some cases a request for future information is a standing data order which is essentially a message file in which a user requests that he or a certain party receives a voice message containing certain information once that information becomes available. In this case it will be appreciated that the trigger event which triggers the generation of the message by the communications apparatus 1 is the fact that the desired information has become available to the communications apparatus 1. The future information may be received by the communications apparatus 1 via the data communications subsystem 11 or the voice communications voice system 14.

In an alternative the future information, once received, may be passed to the data communication subsystem 11 for delivery to the user as a data file.

In other cases the future information subsystem 15 is used to store bids for future information. In this case, users can bid for preferential access to future information once it is available.

The communications apparatus 1 can be arranged so that when future information becomes available, only the highest bidder receives a message containing the information. Alternatively a particular user can be given the information first and there can be a time delay before other users are given the information. In another alternative the information may be delivered to a number of users in a predetermined order.

As mentioned above, the communications apparatus 1 can administer a virtual bidding system. In a case where an original bidder has made a bid for a piece of future information and then a second person bids for the same piece of information, the data management subsystem 12 can generate a message file which is processed by the voice communication subsystem 14 so that the original bidder receives a telephone call asking him if he wishes to raise his bid. If the original bidder raises his bid this information is fed back to the data management subsystem 12 where another message file can be generated and processed so that the second bidder is delivered a voice message to give him an opportunity to raise his bid and so on. This cycle can continue until one of the parties does not increase his bid. Moreover, there is no need to limit the number of bidders to two and in principle any number of recipients can be called and given the opportunity to make a bid. Once the communications apparatus 1 has access to the desired future information then it can be delivered to the highest bidder or in accordance with any ranking structure which has been put into place.

It will be appreciated that such a bidding system can be used to bid for things other than future information, for example bids can be made for goods or services and tenders can be made.

In further alternatives communications apparatus which do not necessarily have any provision for delivering messages by telephone can be arranged for administering requests for future information in the way described above. In such cases the information can be delivered, for example, by e-mail or fax.

Such communications apparatus, with no telephone message delivery capability, may be arranged for administering a virtual bidding system. Such a system would function as described above with the exception that the messages generated by the communications apparatus, the bids and the counter bids would be transmitted by, for example, e-mail or fax.

Such systems would not however benefit from the immediate delivery and reception of information which is possible with the telephone based systems described above.

1. A communications apparatus for use in a communications system, the communications apparatus comprising;
a data storage module for storing information;
a controllable message generating module for generating messages based on information stored in the storage module;
a controllable connecting and transmission module for connecting to terminals via a communications system and transmitting generated messages to said terminals; and
a control module for controlling the message generating module and the connecting and transmission module to cause generated messages to be delivered to selected recipients via selected terminals when predetermined conditions are satisfied, wherein the storage module is arranged to store information in message files each of which is associated with a particular recipient or group of recipients and the contents of each message file determines the operation of the control module so controlling the structure, content, generation and delivery of respective messages.

2. A communications apparatus according to claim 1 which is arranged to receive message files generated externally to the apparatus.

3. A communications apparatus according to claim 1 arranged for connection to a telephone system and arranged to allow generated messages to be delivered as voice messages via the telephone system.

4. A communications apparatus according to claim 1 in which the message generating module is arranged to generate voice messages on the basis of data stored in the storage module.

5. A communications apparatus according to claim 1 in which each message file has an associated template.

6. A communications apparatus according to claim 1 in which the control module is arranged so that a particular recipient or group of recipients are delivered messages when a specified trigger event occurs.

7. A communications apparatus according to claim 1 further comprising a receiving module for receiving information from a remote location via a communication link whereby information received from a remote location can be used to generate and control the generation of appropriate messages for transmission.

8. A communications apparatus according to claim 7 in which the receiving module is arranged to receive information from a remote database and the communications apparatus is arranged to retrieve information from a remote database as required for inclusion in generated messages.

9. A communications apparatus according to claim 1 further comprising a receiving module arranged so that information from a recipient can be received via a telephone system which has been used to make a call to the recipient.

10. A communications apparatus according to claim 1 further comprising an output module for outputting information regarding responses given by recipients.

11. A communications apparatus according to claim 10 in which the output module is arranged so that the responses can be transmitted to a remote location via a communication link.

12. A communications apparatus according to claim 10 in which the output module is arranged to transmit a voice message to a user via a telephone.

13. A communications apparatus according to claim 1 which is arranged for administering requests for future information, such that an appropriate message will be sent to the requesting recipient when the information requested becomes available.

14. A communications apparatus according to claim 1 which is arranged for administering a virtual bidding process, wherein bids may be made by users and received and processed by the apparatus such that a user who wins the bidding process has a right to the information or entity which has been bid for.

15. A communications apparatus connectable to a telephone system comprising,
a data storage module for storing information,
a controllable message generating module for generating messages based on information stored in the storage module,
a controllable dialling and transmission module for dialling numbers of telephones in a telephone system to which the apparatus is connected and transmitting generated messages to said telephones, and
a control module for controlling the message generating module and the dialling and transmission module to cause generated voice messages to be delivered to selected recipients via selected telephones when predetermined conditions are satisfied, wherein the storage module is arranged to store information in message files each of which is associated with a particular recipient or group of recipients and the contents of each message file determines the operation of the control module so controlling the structure, content, generation and delivery of respective messages.

16. A communications apparatus according to claim 15 which is arranged to receive message files generated externally to the apparatus.

17. A communications system comprising a telephone system and a communication apparatus according to claim 1.

18. A method of operating a computer to generate message files, which files are for use in the generation of messages in a communications apparatus of the type claimed in claim 1, the method comprising the steps of:
allowing a user to identify details of recipients who are to be called by the communications apparatus;
allowing a user to identify other information from which messages to be transmitted by the communications apparatus can be generated; and
associating a template which is recognised by the communications apparatus with the identified details and other information to generate message files, wherein the contents of each message file is arranged to determine operation of a control module in a communications apparatus to control the structure, content, generation and delivery of respective messages.

19. A method according to claim 18 comprising the step of extracting at least one of the identified details and the other information from a database.

20. A method according to claim 18 comprising the further step of outputting complete message files for supply to a communications apparatus.

21. A computer program product comprising a computer readable medium comprising software code portions which when loaded and run on a computer cause the computer to execute the steps of claim 18.

22. A communications apparatus for use in a communications system, the communications apparatus comprising hardware and software arranged for performing the following functions;
a) storing information;
b) generating messages based on the stored information;
c) connecting to terminals via a communications system and transmitting generated messages to said terminals; and
a controller for controlling the generation of messages, the connection to terminals and the transmission of messages, to cause generated messages to be delivered to selected recipients via selected terminals when predetermined conditions are satisfied, wherein the information is stored in message files each of which is associated with a particular recipient or group of recipients and the contents of each message file determines the operation of the controller so controlling the structure, content, generation and delivery of respective messages.

23. A method of operating a communications apparatus in a communications system, comprising the steps of:
storing information in a data store;
generating messages based on information stored in the data store;
connecting to terminals via a communications system and transmitting generated messages to said terminals; and
controlling the generation of messages, the connection to terminals, and the transmission of messages to cause generated messages to be delivered to selected recipients via selected terminals when predetermined conditions are satisfied, wherein the data store is arranged to store information in message files each of which is associated with a particular recipient or group of recipients and the contents of each message file controls the structure, content, generation and delivery of respective messages.

24. A communications apparatus for use in a communications system, the communications apparatus comprising;
storage means for storing information;
controllable message generating means for generating messages based on information stored in the storage means;
controllable connecting and transmission means for connecting to terminals via a communications system and transmitting generated messages to said terminals; and
control means for controlling the message generating means and the connecting and transmission means to cause generated messages to be delivered to selected recipients via selected terminals when predetermined conditions are satisfied, wherein the storage means is arranged to store information in message files each of which is associated with a particular recipient or group of recipients and the contents of each message file determines the operation of the control means so determining the structure, content, generation and delivery of respective messages.
